(19) United States
(12) Patent Application Publication
(10) Pub. No.: US 2015/0048135 A1
(43) Pub. Date: Feb. 19, 2015

(54) CENTRE-FED ROLL DISPENSER

(71) Applicant: Gunnar Bredahl, Worms (DE)

(72) Inventor: Gunnar Bredahl, Worms (DE)

(73) Assignee: SCA Hygiene Products AB, Göteborg (SE)

(21) Appl. No.: 14/386,175

(22) PCT Filed: Mar. 28, 2012
(86) PCT No.: PCT/EP2012/055554

§ 371 Date: Sep. 18, 2014

(51) Int. Cl. B26F 3/02; B65H 49/08

(52) U.S. Cl. CPC B26F 3/02; B65H 49/08
USPC 225/42

(57) ABSTRACT

A dispenser includes a cylindrical housing defining an interior volume containing a roll of centre-fed web material. The dispenser also includes a dome part attached to a top of the housing. The dome part includes a dispenser opening through which the web material is fed and a handle opening for receipt of a user's finger for carrying the dispenser. The dispenser has a position in which a base of the dispenser is releasably secured to a horizontal surface so that a central longitudinal axis of the cylindrical volume defined by the dispenser housing extends normally to the table surface. A sticky pad for releasably securing the base of the dispenser to the table surface is provided. The dispensing opening is offset from the central longitudinal axis. An arrangement of restriction and guide blades is provided that interfere with the sheet material as it is being dispensed.

### TECHNICAL FIELD

The present disclosure relates to a dispenser for dispensing sheet material for wiping in one aspect. In other aspects, the present disclosure is particularly concerned with a dispenser for dispensing sheet products of a centre fed roll of sheet material for wiping.

### BACKGROUND

A dispenser of the centre-fed roll kind is known from, for example, the “Plenty Easypull” (RTM) dispenser supplied by SCA Hygiene Products. An example patent publication related to this type of dispenser is WO 2006/098664.

This dispenser is designed to be wall mounted, and so includes a flat area having adhesive tape and screw holes so that the dispenser may be mounted to a vertical wall by an adhesive function and/or by screws. The dispenser includes a housing that is generally cylindrical and defines a generally cylindrical interior volume for receipt of a centre-fed roll therein. An end face of the cylindrical housing includes a dispensing opening that includes teeth around the opening. The sheet products are pulled out through the opening from a central lumen through the roll. The sheet material is tugged against the teeth in order to separate a desired amount of sheet material from the roll.

An end face of the housing on the interior of the housing includes a distribution of radial fins upon which an end face of the roll is seated, in use. There is also included a restriction opening along the path from an end face of the roll when it is seated on the radial fins to the dispensing opening. The restriction opening serves to narrow the sheet material before it reaches the teeth of the dispensing opening so as to ensure a smooth dispensing operation, as compared to fanned sheet material being dragged past the teeth. The restriction opening also grips around the sheet material passing along the dispensing opening to resist the sheet material from retracting relative to the dispensing opening, which could prevent a user from being able to easily reach the end of the sheet material to pull upon for dispensing the sheet material. The radial fins separate the restriction opening and the end face of the roll to ensure smooth and stick-free dispensing. Yet further, a cavity is provided in an axial gap between the dispensing opening and the restriction opening, which accommodates an end of the sheet material for grasping by a user.

It is considered desirable by the present applicant to make such a dispenser portable so that it can be wall mounted if desired and can also be moved around a usage site if desired. WO 2008/085090 A1 discloses a portable dispenser for a centre-fed roll of sheet material. This dispenser is made of a soft, flexible, textile type material. The soft dispenser includes a handle to allow it to be carried around and used where desired. The tissue dispensing action requires a two-handed operation, one hand for stabilizing the dispenser, such as at the handle, and the other hand for pulling and tearing the sheet material.

It is an object of the present disclosure to provide a portable dispenser for containing and dispensing a centre-fed roll of sheet material that allows one-handed dispensing of the sheet material, while avoiding tipping of the dispenser in most, if not all, uses.

The “Easypull” RTM dispensing path makes use of radial fins and a restriction opening. Dispensing using such is smooth, but can stick a little as the roll nears a used-up state because the sheet material is required to pass circumferentially between radial fins, which tends to provide a blocking function, and because the dispensing path has become more bent as the lumen through the roll increases in diameter as compared to the restriction opening.

It is an object of the present disclosure to provide a smooth dispensing path even as the roll approaches a used-up state, while also providing tissue fallback prevention.

Although not of the type of dispenser to which the present disclosure is particularly concerned (centre-fed roll dispenser), CA 2146591 A1 discloses a dispenser (periphery-fed) for a single roll of toilet tissue that can be secured to a surface through the use of suction cups. As a releasable securement means, suction cups are sub-optimal because they can only be applied to limited types of surfaces and they tend to lose securing power over time. Further, suction cups are difficult to release without, for example, a special release tab.

It is a further object of the present disclosure to provide a dispenser with optimal releasable securement means.

### SUMMARY

In a first aspect of the present disclosure, there is provided a dispenser comprising a housing defining an interior cylindrical volume for containing a centre-fed roll of sheet material for wiping, means for releasably and repeatedly securing a bottom of the dispenser to a horizontal surface and a dispensing opening located at a top portion of the dispenser, wherein the bottom of the dispenser and the top portion are located at opposed ends of the cylindrical volume, wherein the dispensing opening includes a tear-off part that is more vertically oriented than horizontally oriented when the bottom of the dispenser is releasably secured to the horizontal surface so that an action for separating sheet material passed through the dispensing opening from the roll involves grasping an end portion of the sheet material and tugging in a downward motion against the tear off part.

According to the first aspect of the present disclosure, the dispenser is able to be releasably and repeatedly secured to horizontal surfaces, thereby allowing the dispenser to be carried around a usage site and located where it is desired. The releasable securement also allows one-handed dispensing as the dispenser is stabilized by securing it to the horizontal surface. The dispensing opening and the releasable securement means are located at opposed ends of the volume defined by the housing for containing the roll of sheet material. The tear-off part is more vertically oriented than horizontally oriented so that a tearing force is applied more downwardly than horizontally, which will reduce a force tending to tip the dispenser. This means that the releasable securement means can have a lower securement force with the horizontal surface, making it easier for a user to release the securement means for moving the dispenser.

The orientation of the tear off part is to be assessed with respect to a direction that part of the sheet material is moved into contact with the tear off part in an operation of separating the sheet material from the roll. If the direction of movement is more downward than horizontal, then the tear off part is more vertically oriented than horizontally oriented. Further, the tear-off part is located on a lower side of the dispensing opening. That is, the dispensing opening is configured such that the sheet material is pulled along a central axis of the dispensing opening for feeding a desired length of sheet material through the dispensing opening, and is yanked in a downward direction to separate the desired length from the roll in the interior volume, whereby the yanking moves part of the sheet material into contact with the tear off part in a more downward direction than horizontal direction.

The means for releasably and repeatedly securing may be one or more suction cups arranged on the bottom of the dispenser, a sticky pad arranged on the bottom of the dispenser, a tacky layer arranged on the bottom of the dispenser or other such means so that securement is achieved easily by pressing the bottom of the dispenser against the horizontal surface. The means for releasably and repeatedly securing is preferably a sticky pad as described below with respect to the third aspect of the present disclosure. In this way, securement is achieved by simply pressing the bottom of the dispenser against the horizontal surface.

The means for releasably and repeatedly securing may be arranged on the bottom of the dispenser, whereby the dispenser is securable to the horizontal surface with the central longitudinal axis of the cylindrical volume extending vertically or in a normal direction to the horizontal surface. The bottom of the dispenser may extend perpendicularly to the central longitudinal axis. The bottom of the dispenser may be circular when viewed in plan. The means for releasably and repeatedly securing may be positioned on an outer surface of the bottom of the dispenser.

The dispensing opening may define a central axis passing through it that intersects with a central axis of the cylindrical volume. This feature requires the dispensing opening to be located to one side of the housing and to be oriented so as to be at an angle relative to a horizontally oriented dispensing opening. An angle defined between the central axis of the dispensing opening and the central longitudinal axis of the cylindrical volume may be between 10° and 90° or 20° and 80° or between 30° and 70° or between 40° and 50°. The dispensing opening may face so that the central axis thereof extends upwardly, at an angle relative to the central longitudinal axis of the interior volume, which extends vertically when the housing is seated on the bottom on a horizontal surface. The closer the angle to the vertical, the greater the tipping force when yanking the sheet material for separating the sheet material. The closer the angle to the horizontal, then the greater turn along the dispensing path, which thereby reduces dispensing smoothness.

The dispenser may comprise guide blades for guiding the sheet material through the offset dispensing opening in a smooth way, as described below with respect to the second aspect of the present disclosure.

The dispenser may comprise a dome-part positioned on top of the housing and including the dispensing opening, wherein the dispensing opening is located offset from an apex of the dome. The dome provides a structure enabling the tear off part to be relatively vertically oriented by locating the dispensing opening offset from the apex. A central axis of the dome passing through the apex of the dome and a central axis of the dispensing opening may define an angle between them of at least 10°, 20°, or 30°, thereby ensuring that the tear-off part can be positioned at a lower part of the dome, providing vertical orientation to the tear-off part. A central axis of the cylindrical volume passes through the apex of the dome part.

The tear off part may include serrations or teeth extending around at least a lower part of the dispensing opening. The teeth or serrations may point more upwardly than horizontally, with respect to the bottom of the dispenser being seated on the horizontal surface. The teeth may be fairly sparse so as to provide less than 100, 50, 40, or 30 teeth around the dispensing opening. The teeth may be relatively large so as to provide a visible saw-tooth formation. The teeth may extend by at least 5 mm from a periphery connecting the base of each tooth.

The teeth may be provided by a jagged top edge of a wall part that extends vertically or substantially vertically, whereby the teeth form a lower edge of the dispensing opening.

The dispenser may comprise an openable part connected to the housing in order to allow the housing to be refilled with a new roll of centre-fed sheet material. The openable part may be a top part of the housing including the dispensing opening. The top part may be the dome part described above. The dome part may be removably connected to the housing, such as by a bayonet type connection or any other form of removable connection.

In particular, a removable connection should require movement of at least part of the openable part in more than one direction, perhaps perpendicular directions, relative to the housing in order to release the connection. The connection may require a lock button to be pressed in order to release relative movement between the openable part and the housing to allow the openable part to be removed from the housing. In particular, the lock button may release relative movement in the more than one direction to remove the openable part from the housing. These features ensure that the openable part and the housing can not be accidentally disconnected as a result of a dispensing or carrying operation.

A shape of the outside of the housing may be cylindrical.

A bottom wall of the housing extends parallel to a bottom end face of the roll of sheet material. The bottom end face of the roll of sheet material may be seated on an inside surface of the bottom wall when the dispenser is secured to the horizontal surface. The means for releasably and repeatedly securing may be arranged on an outer surface of the bottom wall so that the dispenser can be releasably and repeatedly secured to the horizontal surface with the horizontal surface extending parallel to the outer surface of the bottom wall.

The dispenser may comprise a handle to ease portability (mobility) and for releasing the dispenser from the horizontal surface. The handle may be provided in the dome part, perhaps as an opening in the dome part.

A system may be provided comprising the dispenser and a wall mounting part that is to be fixed to a vertical wall, whereby the dispenser is releasably connectable to the wall mounting part to allow the dispenser to be portable when released from the wall mounting part and to be docked at a fixed location when connected to the wall mounting part. The wall mounting part may comprise adhesive tape or other adhesive means and/or screw openings for fixing the wall mounting part to the vertical wall.

In a particular implementation of the wall mounting part, first and second arms are provided that spread apart to receive the housing and include first and second ribs to snap fit in first and second slots in the housing when the first and second arms are spread apart. The wall mounting part may include a flat portion for seating against the vertical wall.

In a second aspect of the present disclosure, there is provided a dispenser, comprising a housing defining an interior cylindrical volume defining a central axis, the cylindrical volume for containing a centre-fed roll of sheet material and a dispensing opening through which the sheet material is dispensed, and at least one restriction blade defining a restriction tunnel at least partly surrounding the dispensing opening, wherein the restriction blade defines an entrance end of the restriction tunnel and a dispensing end of the restriction tunnel through which sheet material passes to pass out of the dispensing opening, and wherein the restriction blade has an edge at the entrance end against which an end face of the roll is to be seated, which edge thus extends along a plane perpendicular to the central longitudinal axis of the cylindrical volume.

The at least one restriction blade thus offers a tunnel for guiding the sheet material into a restricted state as it passes along the dispensing path to the dispensing opening. The at least one restriction blade also provides a seat for the end face of the roll, so that the tunnel separates an end face of the roll from the dispensing opening, as required for successful dispensing. The seat comes into use when the dispenser housing is oriented with respect to gravity so that the dispensing opening faces downwardly and the central longitudinal axis is aligned with vertical. Further, the restriction means is provided in the form of a blade with an edge, which offers the above function in a way that minimizes contact, and thus friction, with the sheet material, to ensure smooth dispensing with low risk of the sheet material prematurely separating from the roll. A central axis of the restriction tunnel may extend parallel (or substantially parallel) to the central axis of the cylindrical volume, yet offset therefrom.

The at least one restriction blade may extend around a majority of the dispensing opening. The entrance end of the restriction tunnel may define an opening marginally smaller or larger or the same size as the dispensing opening. The entrance end of the restriction tunnel provides a significant restriction in that the opening defined thereby has a largest dimension extending across the restriction opening of a half or less, a third or less or a quarter or less of an axial length of the cylindrical volume.

The dispensing opening may be offset from the central axis of the cylindrical volume. The offset dispensing opening provides a kink or bend along the dispensing path, yet the blade configuration has been found to reduce the chances of premature sheet material separation.

The at least one restriction blade provides a portion of the restriction tunnel located radially between the central axis of the cylindrical volume and the dispensing opening. This central portion of the at least one restriction blade provides a sheet material fallback preventing function.

The portion of the restriction tunnel is curved so as to be radially closer to the central axis at a central part than at opposed outer parts along the restriction blade. This ensures that an elliptical space is provided as the central portion of the tunnel is convexly curved relative to the central axis, while a central lumen of the roll is concavely curved relative to the central axis. The concave and convex curves overlap to form a space through which the sheet material is able to pass into the restriction tunnel.

The dispensing end of the restriction tunnel may be an exit to the tunnel provided by the dispensing opening itself. The dispensing opening may define teeth along at least part of the opening against which the sheet material is able to be separated from the roll.

The at least one restriction blade may extend at least substantially radially on opposed sides of the dispensing opening, from a circumferential plane extending along an outer circumferential edge of the cylindrical volume to a central portion of the cylindrical volume.

The dispenser may further comprise at least one guide blade extending at least substantially radially from a circumferential plane extending along an outer circumference of the cylindrical volume, the at least one guide blade intersecting with the at least one restriction blade, wherein the at least one guide blade defines an edge upon which an end face of the roll is to be seated, which edge thus extends along the plane perpendicular to the central axis of the cylindrical volume.

The edge of the guide blade provides a surface upon which the sheet material runs so as to be guided toward the restriction tunnel. The edge is a thin contact area, which ensures a low friction, smooth guiding function. Further, the edge provides part of a seat for the end face of the roll to ensure separation of the end face from the dispensing opening. The seat comes into use when the dispenser is oriented with respect to gravity so that the dispensing opening faces downwardly.

The at least one guide blade may comprise a radially extending portion and a curved transition portion between the radial portion and the intersection with the restriction blade. The curved transition portion may be convex relative to the central axis of the cylindrical volume.

The curved transition portion provides a smooth transition to the restriction tunnel as the sheet material runs along the guide blade, to ensure a smooth dispensing function.

The dispenser may comprise first and second such guide blades defining a sector relative to the cylindrical volume therebetween. The sector may be at least a quadrant. This provides sufficient distribution of guide blades for achieving an effective roll seat function and guide function, without providing so many guide blades as to hinder a smooth dispensing function.

The at least one restriction blade and/or the at least one guide blade described above may be combined with any of the features described with respect to the first aspect of the present disclosure. In particular, the smooth dispensing function offers a low dispensing force, which is useful with respect to minimizing the power required for the releasable securement means. Further, an offset dispensing opening is a common feature to both aspects of the present disclosure and the advantages described with respect to both aspects can be obtained synergistically when the two aspects are combined.

The at least one restriction blade may be provided inside the dome part described with respect to the first aspect of the present disclosure.

In a third aspect of the present disclosure, there is provided a portable sheet dispenser comprising a housing defining an interior area for containing a roll of sheet material for wiping and a dispensing opening through which the sheet material is dispensable, and a sticky pad made from a sticky elastomeric polymer composition so that the dispenser can be secured to a table surface or other such surface and released from the surface by peeling the sticky pad from the surface, wherein the sticky pad allows the dispenser to be repeatedly secured and released from the surface.

The dispenser can be stuck to a table or other such surface, allowing the sheet products to be dispensed one-handed. The dispenser can be released and carried about to provide a portable dispenser. A peelable sticky pad is able to be repeatedly stuck to table surfaces without leaving residue and without losing its stickability to an overly detrimental degree. Further, the range of suitable surfaces to which the pad is stickable is relatively broad. This compares favourably with other securement means such as suction cups in which the securement decreases with time applied to a surface and only allows securement to a limited number of surfaces.

The dispenser may be a centre-fed roll dispenser, as described above. That is, the dispenser housing defines an interior cylindrical volume for containing a roll of centre-fed sheet material for wiping and a dispensing opening is arranged to receive sheet material from an end face of the roll.

The housing may be elongate along a longitudinal axis. The sticky pad may be arranged on a base extending perpendicularly to the longitudinal axis. The dispensing opening is arranged at a top end of the dispenser opposite to the base end, relative to the longitudinal axis.

The sticky pad may be adhered to the dispenser using a separate adhesive. Preferably, the sticky pad is stuck to the dispenser using the same sticking mechanism by which the sticky pad sticks to the table or other such surface.

The sticky pad may be adapted so that it preferentially sticks to the dispenser as compared to the table or other such surface. This could be done merely by the fact that the sticky pad has been stuck to the dispenser for a longer period of time than the table surface because it is manufactured with the pad in place. Alternatively, the sticky pad may include a greater contact surface area with the dispenser than the table surface. This could be implemented with a more textured surface on the table side than the dispenser side or a greater recess area on the table side.

The dispenser may include a release cover disposed over the sticky pad that has to be removed to stick the dispenser against the table or other such surface.

The degree of stickiness is selected so as to balance the requirements of being sticky enough to ensure one handed dispensing without the dispenser releasing from the table or other such surface and not being so sticky as to make it too hard for all users to peel the sticky pad from the surface to release the dispenser from the surface.

The tacky elastomeric polymer composition may comprise or consist of
(A) one or more elastomeric polymers, preferably elastomeric polyurethane polymers which optionally have been produced in the presence of more than 0 to 5% by weight, for instance from 0.3 to 2.0% by weight of a catalyst,
(B) optionally filler in an amount of more than 0 to less than 50% by weight, preferably of from 1 to 30% by weight based,
(C) optionally additives, which are preferably selected from more coloring agents, water-binding substances, flame-proofing agents, UV stabilizers, plasticizers, and tackifiers, in a total amount of more than 0 to 25% by weight, preferably of from 0.5 to 10% by weight,

each based on the total weight of the composition.

The one or more elastomeric polymers (A) may be selected from elastomeric polyurethane polymers and preferably one of the following conditions is met:
(i) no filler is present, optionally plasticizers and/or tackifiers are present as sole additives, and the elastomeric polymer composition is transparent or translucent,
(ii) filler and/or coloring agents are present, optionally plasticizers and/or tackifiers are present as sole additives, and filler and/or coloring agents have been selected so as provide the mat with a color matching the color of the outer surface of the dispenser on which the mat is to be affixed.

The part of the dispenser to which the sticky pad is applied may be made of a plastic material that contains, in addition to carbon and hydrogen atoms, polar structural units preferably selected from carboxy (O—C═O), amide (N—C═O) and nitrile (CN).

The sticky pad may have a durometer hardness in the range of 20 to 85, 35 to 75, or 40 to 70, e.g. 45 to 65, on the Shore (00) scale according to ASTM D2240-05 (reapproved 2010).

### BRIEF DESCRIPTION OF THE FIGURES

FIG. 1 shows a dispenser forming an embodiment of the present invention disclosure. The dispenser includes a cylindrical housing defining an interior area containing a roll of centre-fed web material. The dispenser also includes a dome part attached to a top of the housing. The dome part includes a dispenser opening through which the web material is fed and a handle opening for receipt of a user's finger for carrying the dispenser. The dispenser is shown in a position in which a base of the dispenser is releasably secured to a horizontal surface so that a central longitudinal axis of the cylindrical volume defined by the dispenser housing extends normally to the table surface. A sticky pad for releasably securing the base of the dispenser to the table surface is not shown in FIG. 1.

FIG. 2 shows a corresponding view of the dispenser as shown in FIG. 1, except that FIG. 2 shows a rear side of the dispenser, rather than a front side as in FIG. 1. From the rear of the dispenser, the handle opening can be seen, as can first and second longitudinally oriented slots for receipt of projections of a wall mounting bracket.

FIG. 3 shows a view of the dispenser so that a base of the dispenser can be seen. In particular, a sticky pad is secured to the base of the dispenser to allow the dispenser to be repeatedly and releasably secured to the table surface.

FIG. 4 shows a wall mounting bracket that includes first and second holes for receiving screws therein to fix the wall mounting bracket to a vertical wall. The wall mounting bracket includes a flat rear surface for lying flush against a vertical wall and an arcuate front surface, conforming to part of the circumference of the cylindrical housing. The wall mounting part includes first and second projections that snap fit into first and second slots in the dispenser housing in order to removably mount the housing to the wall mounting part.

FIG. 5 shows a perspective view of a top of the dome part. This view shows the opposed locations of the dispensing opening and the handle opening, as well as bayonet projections at the bottom of the dome part for removably attaching the dome part to the dispenser housing.

FIG. 6 shows a bottom view of the dome part so that an inside of the dome can be seen. The bottom view shows an arrangement of restriction and guide blades that interfere with the sheet material as it is being dispensed.

FIG. 7 shows a cross-sectional view of the dome part in a cross-section defining a diametric plane passing through the dispensing opening and the handle opening extending from a top to a bottom of the dome part. The cross-sectional view shows the depth of the blade in extending from the top of the dome part to a bottom of the dome part.

### DETAILED DESCRIPTION

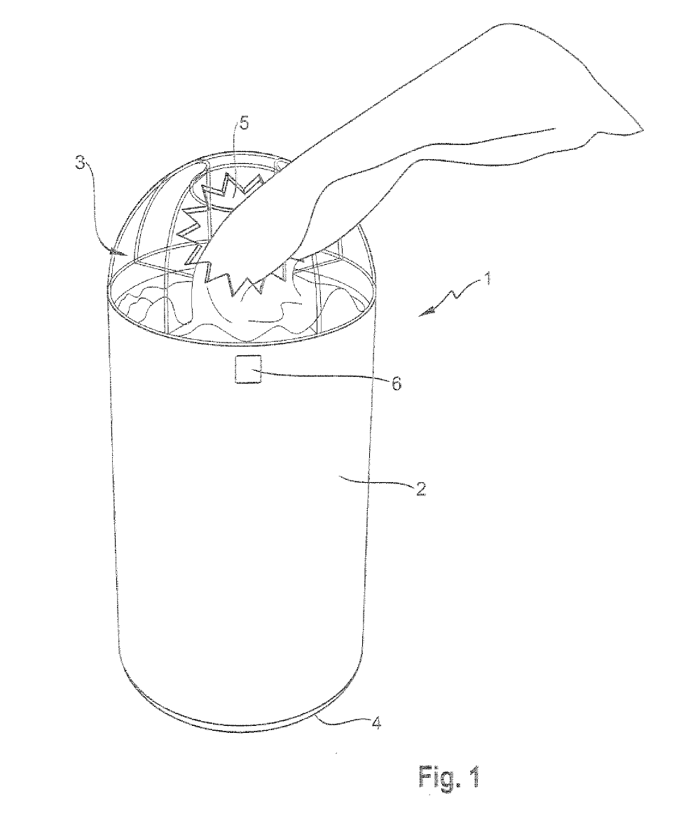

FIG. 1 shows a dispenser 1 comprising a cylindrical housing 2 and a dome part 3. The cylindrical housing 2 defines a cylindrical interior volume for containing a centre-fed roll of web material for wiping. The cylindrical volume may define a height of the cylinder of between 8 cm and 50 cm, or between 20 cm and 50 cm. The cylindrical housing 2 includes a slight conical taper, but is, nonetheless, a cylindrical housing 2. The web material is preferably a dry web material paper product. The dispenser 1 also includes a base upon which the dispenser 1 can be stood on a table or horizontal surface and a dispensing opening 5 positioned above a top end face of the roll of web material when the dispenser 1 is stood on its base 4 on a horizontal surface.

The dispensing opening 5 includes a plurality of triangle shaped teeth against which the sheet material can be forced in a direction perpendicular to the dispensing direction to separate the sheet material from the rest of the roll.

FIG. 1 shows a hole 6 into which a corresponding protrusion 7 of the dome part 3 resiliently snap-fits in order to rotationally lock the dome part 3 to the housing 2. To undo this lock, the corresponding protrusion 7 of the dome part 3 is pressed inwardly to disengage it from the hole 6 in the housing 2 (see also FIG. 7).

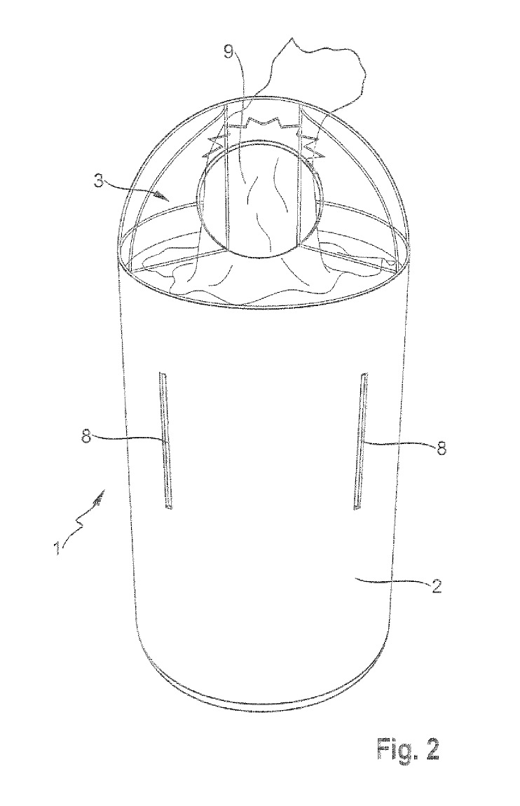

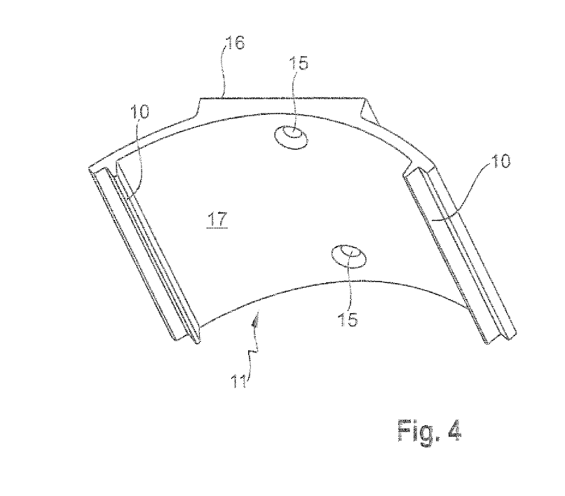

The dispensing opening is, in the present specification, considered to be provided on a front side of the dispenser 1 in a plane perpendicular to a central longitudinal axis of the cylindrical housing 2. FIG. 1 shows a view of the dispenser 1 from the front side. FIG. 2 shows a view of the dispenser 1 from a rear side. The rear side of the dispenser 1 includes first and second slots 8 that are longitudinally oriented so as to extend parallel to a central longitudinal axis of the housing 2. The first and second slots 8 are positioned to receive corresponding first and second projections 10 of a wall mounting part 11 (FIG. 4 and further described below). The slots 8 are marginally further spaced apart than the projections 10 so as to require the wall mounting part 11 to resiliently spread open a little in order to engage the slots 8 and the projections 10 to thereby mount the dispenser 1 to the wall mounting part 11.

FIG. 2 also shows a handle opening 9 so as to receive at least one finger, and in the shown embodiment, at least the fore and middle fingers to allow the dispenser 1 to be conveniently carried around. The dispenser 1 is thus portable and is also designed to be fixed to a wall to thereby offer both a wall fixed dispenser 1 and a portable dispenser 1, depending on a user's needs.

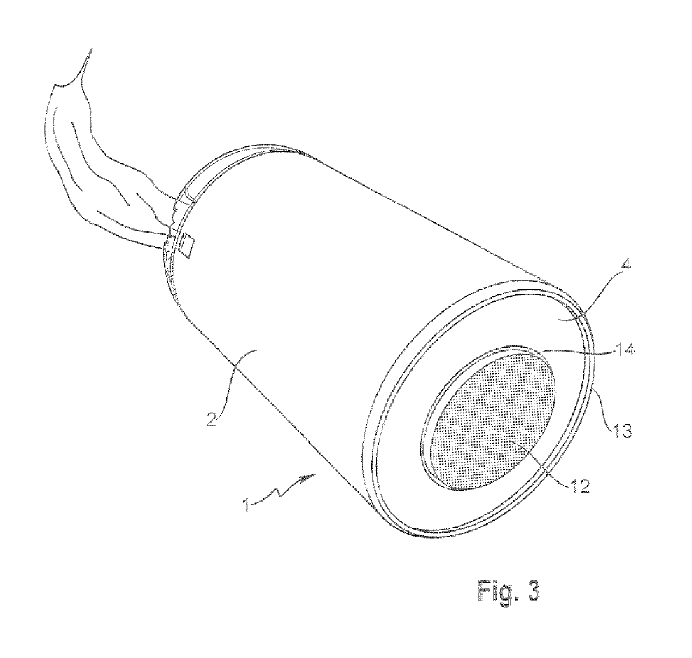

FIG. 3 shows a view of the base 4 of the dispenser 1, which shows a sticky pad 12 secured to the base 4. The base 4 includes a rim 13 disposed about a periphery thereof that projects from the rest of the base 4, so that the rest of the base 4 is recessed relative to the rim 13. The sticky pad 12 projects marginally relative to the rim 13 in order to define a contact surface for the dispenser 1 with the horizontal surface when the dispenser 1 is stood up. The sticky pad 12 is thus arranged in the recess of the rest of the base 4 as compared to the rim 13. In this way, a relatively thick sticky pad 12 can be used without the pad projecting too far relative to the rim 13 that a tipping problem is created. The sticky pad 12 is made of materials as described above to allow the dispenser to be repeatedly and releasably secured to the horizontal surface, where the securement is performed by simply pushing the dispenser 1 onto the surface, base first, and the releasing is performed by peeling the pad 12 from the horizontal surface.

The sticky pad 12 is stuck to the base 4 by the same sticking mechanism by which the sticky pad 12 works to secure the dispenser 1 to the horizontal surface. The sticky pad 12 preferentially sticks to the base 4 for a number of reasons, including the fact that the sticky pad 12 will have been stuck to the base for a longer period of time than to the horizontal surface and the sticky pad material tends to increase its stickiness over time (as compared to other securement means such as suction cups that decrease in securement force over time). Also, the sticky pad 12 includes a peripheral groove on the horizontal surface side and is smooth on the dispenser side, which creates a greater contact surface area with the base 4 than the horizontal surface, thereby promoting preferential securement to the dispenser 1 than the horizontal surface.

FIG. 4 shows a wall mounting part that is provided with the dispenser 1 as part of a system. The wall mounting part 11 includes an arcuate front surface 17 conforming with an outer cylindrical surface of the housing 2. The wall mounting part 11 also includes a flat rear surface 16 conforming with a vertical wall so that the wall mounting part 11 can rest with the flat surface 16 lying flush against the vertical wall. The wall mounting part 11 includes first and second screw receiving holes 15 so that the wall mounting part 11 can be screwed to the vertical wall to fix the wall mounting part 11 to the vertical wall. The wall mounting part 11 can be thought of as providing first and second arms that have at each end a protrusion 10. The wall mounting part 11 is made of a resilient material to allow the arms, and thus the protrusions 10, to spread apart. The arms of the wall mounting part 11 spread apart to allow the protrusions 10 to snap fit into the first and second slots so that the dispenser 1 can be mounted to the wall mounting part 11.

The wall mounting part 11 can thus provide a docking station to fix the dispenser to the wall, while the dispenser 1 can be removed from the wall mounting part 11 so that the dispenser 1 is portable and can be releasably secured to horizontal surfaces using the sticky pad 12. The dispenser 1 is thus capable of both being docked and mounted to a vertical wall and also carried about and releasably and repeatedly secured to horizontal surfaces.

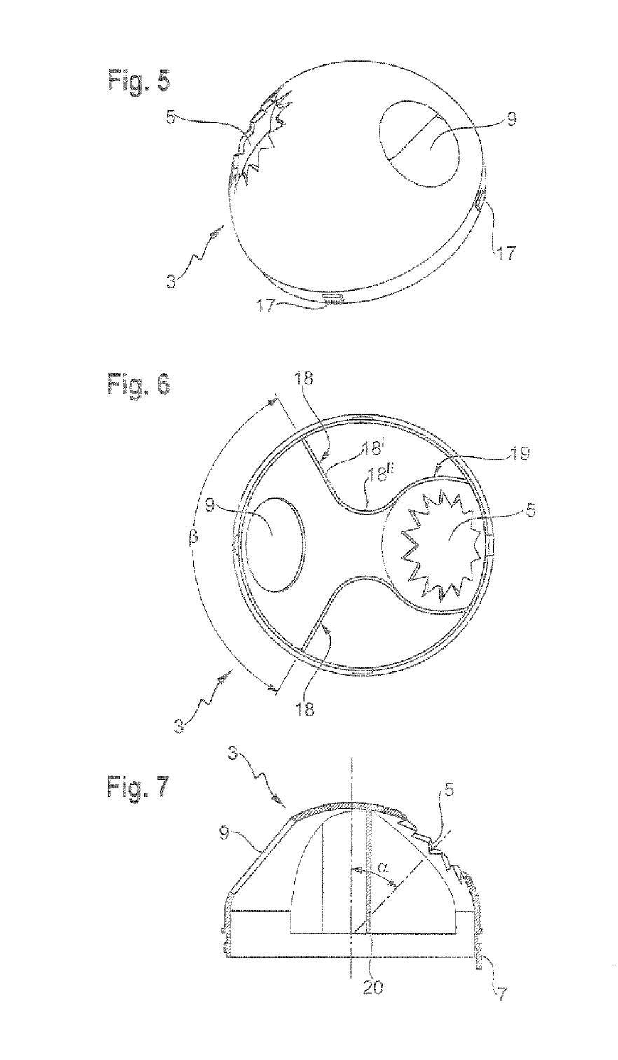

FIGS. 5 to 7 show various views of the dome part 3 that is to be attached to the housing 2. The dome part 3 includes a dispensing opening 5 and a handle opening 9. The dispensing opening 5 is offset from a central longitudinal axis of the cylindrical housing 2 so that the dispensing opening 5 is offset from a central apex of the dome part 3. In this way, a bottom set of teeth of the dispensing opening 5 is positioned so that, when the sheet material is pulled along an axis passing centrally through the dispensing opening 5 and when the dispenser is stood on its base 4 on a horizontal surface, the user then has to pull downwards in order to engage the sheet against the bottom set of teeth. This means that the force imparted by the user onto the dispenser 1 when attempting to separate the sheet material from the rest of the roll is substantially in a downward direction along a central longitudinal axis of the housing 2, rather than perpendicular to this direction, which will reduce the tendency for the dispenser 1 to tip over. This is particularly important in combination with the sticky pad 12, since the sticky pad 12 can be of reduced stickiness.

Put another way, a central axis passing through the dispensing opening 5 is angled relative to a central longitudinal axis of the housing by between 5° and 90°, 15° and 80°, 25° and 70°, 35° and 60°, and 40° and 50°. In the shown embodiment, the angle a (FIG. 7) is about 45°.

The dome part 3 includes a plurality of bayonet tabs 17 in a bottom skirt portion of the dome part 3 that are to be received in bayonet channels provided on an inside surface of the housing 2 to require the dome part 3 to be mounted to the housing 2 in a dual axis motion, namely by inserting the tabs 13 in a downward, axial direction and then rotating the dome part 3 relative to the housing 2 in a circumferential direction. When the dome part 3 is rotated in the closing direction relative to the housing 2, the locking tab 17 snap fits into the hole 6 in the housing 2 to lock the closed position.

The dome part 3 also includes restriction and guide blades 18, 19 inside the dome part 3. Bottom edges 20 of the guide and restriction blades 18, 19 extend along a plane that is perpendicular to a central longitudinal axis of the housing 2 passing through an apex of the dome part 3. It is the bottom edges 20 that can be seen in the bottom view of FIG. 6. These bottom edges 20 provide a seat against which an end face of the roll of sheet material contained in the housing 2 can rest when the dispenser 1 is oriented with the housing 2 above the dome part 3 and the dispensing opening 5 so that the weight of the roll is no longer supported by the base 4, as when the dispenser 1 is stood up on a horizontal surface, but instead is supported by the bottom edges 20 of the guide and restriction blades 18, 19.

The restriction blade 19 surrounds most of the dispensing opening 5. The restriction blade 19 extends from a first radial point on an inside surface of the dome part 3 on one side of the dispensing opening 5 to a second radial point on the other side of the dispensing opening 5 and an arcuate wall connects these radial points in order to provide a sheet material providing a tunnel that restricts the sheet material on its way out of the dispensing opening 5, where the restriction is to be understood as compared to the width of the sheet material (defined in the axial direction of the roll of sheet material).

First and second guide blades 18 are also provided. The first and second guide blades 18 include radially extending parts 18′ extending from an inside surface of the dome part 3 to a radial position set back from a central longitudinal axis of the dome part 3 extending through an apex of the dome part 3. The first and second guide blades 18 also include a connecting portion 18″ that connects a central end of the radially extending portion 18′ to the restriction blade 19. The connecting portions 18″ provides an arcuate transition into the restriction blade 19. The radially extending part 18′ of the guide blades 18 define a sector between them of between 90° and 180°, 95° and 170°, 100° and 160°, 105° and 150°, 110° and 140° and 115° and 130°. In the shown embodiment, the angle β (FIG. 6) is 120°. A central area of the dome part 3 encompassing central parts of the guide and restriction blades 18, 19 define convex surfaces relative to the central longitudinal axis.

The radial parts 18′ of the guide blades 18 are disposed in an opposed half of the dome part 3 than the restriction blade 19.

An exemplary use of the dispensing system detailed above with respect to the figures will now be described.

To load the dispenser 1 with a fresh roll of centre-fed sheet material, the projection 7 of the dome part 3 is pressed inwardly so as to disengage the projection 7 from the hole 6. With the projection 7 pressed inwardly, the dome part 3 can be rotated in an opening rotational direction to a stop point and then lifted so as to separate the dome part 3 and the housing 2 in a way defined by the channels on the inside of the housing in which the tabs 17 on the dome part 3 run. The dome part 3 is thus separated from the housing 2 to allow a fresh roll of centre-fed sheet product to be inserted in the housing 2.

The dome part 3 is then attached to the housing 2 by carrying out the opening operation in a reverse sense until the locking projection 7 of the dome part 3 is snap fit engaged in the hole 6 in the housing 2.

The wall mounting part 11 is secured to a vertical wall by inserting screws into the wall through the holes 15 in the wall mounting part 11. This provides a docking station fixed to the vertical wall to which the dispenser 1 can be mounted. The dispenser 1 can be mounted to the vertical wall by aligning the first and second slots 8 in the housing 2 with the first and second projections 10 of the wall mounting part 11 and pushing the dispenser toward the wall mounting part 11 so as to spread the projections 10 apart in order to engage the projections 10 in the first and second slots 8 in the housing 2. The dispenser 1 is designed so that the base 4 faces upwardly and the dispensing opening 5 is positioned below the base 4, when the dispenser 1 is mounted in the wall mounting part 11. In this orientation, an end face of the roll rests against bottom edges 20 of the guide and restriction blades 18, 19.

The dispenser 1 can also be carried around the room by detaching it from the wall mounting part 11 by pulling the dispenser 1 away from the wall mounting part 11 to disengage the projections 10 from the first and second slots 8. A user may insert a forefinger and a middle finger into the dispensing opening 9 to carry the dispenser 1. The dispenser 1 may be secured to a horizontal surface, such as a table surface, by pressing the base 4 against the table surface. This causes the sticky pad 12 to contact the table surface and form a securement interaction between the dispenser 1 and the table surface. At least for the first hours, and maybe even for the first few days, the strength of the securement between the sticky pad 12 and the table surface increases. The dispenser 1 can be removed from the table surface by pulling the dispenser 1 at an angle, which is assisted by the angled position of the handle opening 9 as shown in FIG. 7, thereby causing the sticky pad 12 to peel away progressively from one peripheral side to the opposite peripheral side of the sticky pad 12.

Sheet material is fed through the dispensing opening 5 and dispensed from a central lumen of the roll of sheet material. In the wall mounted configuration, this dispensing motion involves the user pulling in an off-vertical downward direction to withdraw the sheet material through the dispensing opening 5. In the table mounted configuration with the dispensing opening 5 facing upwards, the dispensing motion involves a using pulling in an off vertical upward direction. In both configurations, an angle from the centre of the product roll through a centre of the dispensing opening 5 is offset from vertical. The dispensing opening 5 includes jagged teeth against which the sheet material is forced in a snatching motion that is more vertically oriented than horizontally oriented because of the orientation of the teeth at the bottom of the dispensing opening 5 (where bottom is to be understood with the dispenser 1 stood on the base on the horizontal surface). This is particularly useful when the dispenser 1 is secured to a horizontal table surface by the sticky pad 12 because forcing the sheet material against the teeth involves a downward tug on the dispenser 1, which provides a relatively reduced tipping force to the dispenser 1.

The sheet material unravels from the centre of the roll in a particular sense relative to the clock face, which causes the sheet material to run along at least part of a first of the guide blades 18 and then along at least a part of the second of the guide blades 18, which both guide the sheet material toward the restriction tunnel defined by the restriction blade 19. The restriction blade 19 restricts the sheet material relative to a width or lateral direction of the sheet material to prevent tissue fallback in conjunction with the natural angle provided by the offset restriction opening 5 relative to a central axis of the roll. At the start of sheet dispensing from a new roll, the central lumen is relatively narrow, which means that it is mostly the arcuate part 18″ of the guide blades 18 that serve the sheet guiding function. As the sheet material becomes more depleted and the central lumen grows, the radially extending parts 18′ become increasingly important in guiding the sheet material toward the centre and thus toward the entrance to the restriction tunnel defined by the restriction blade 19. When the dispenser 1 is stood on its base on the horizontal surface, the restriction tunnel defined by the restriction blade 19 serves to grasp the sheet material laterally to hinder or prevent tissue fallback.

Various alternatives to the dispenser 1 of the above given embodiment may be provided.

For example, it is envisaged that the principles of the present disclosure could be provided to other types of centre fed roll dispensers, such as wet wipe material. This would require a number of modifications, particularly to seal the dispenser 1, but the principles of being able to releasably secure such a dispenser to a horizontal surface and also (optionally, additionally or alternatively) dock it to a fixed point on a vertical wall, along with the (optional, additional or alternative) associated advantages of the offset dispensing opening and the (optional, additional, or alternative) restriction and guide blades would be applicable in such a dispenser.

In the shown embodiment, the jagged teeth extend about an entire periphery of the dispensing opening. It can be imagined that the jagged teeth may extend about only a bottom part of the dispensing opening (when the dispenser 1 is positioned on its base 4 on a horizontal surface), while a top part of the periphery of the dispensing opening could be a relatively smooth surface. This will allow a user to withdraw the sheet material against the top part of the dispensing opening without tearing it and then separate the withdrawn sheet material by engaging the sheet material against the jagged part of the dispensing opening.

In another alternative, the sticky pad is attached to the dispenser using means other than the inherent sticking properties of the sticky pad. For example, the sticky pad could be attached using an adhesive layer to the dispenser.

In a variation that is not in accordance with all aspects of the present disclosure, it can be imagined that the dispenser 1 could be provided with a flattened side portion so that the dispenser 1 can be oriented horizontally, when the flattened side portion rests on a horizontal surface. The flattened side portion could include the sticky pad described above to allow the dispenser to be secured to the horizontal surface in a way enabling one handed dispensing of the sheet material.

The roll of sheet material may or may not include lines of weakness separated along a longitudinal direction of the sheet material to define individual sheet products. The sheet material may be a paper based material. The sheet material may be a centre-fed toilet paper roll or a centre-fed roll of sheet material more suited to wiping liquid spillages.

1. A dispenser comprising a housing defining an interior cylindrical volume for containing a centre-fed roll of sheet material for wiping, means for releasably and repeatedly securing a bottom of the dispenser to a horizontal surface and a dispensing opening located at a top portion of the dispenser, wherein the bottom of the dispenser and the top portion are located at opposed ends of the cylindrical volume, wherein the dispensing opening includes a tear-off part that is more vertically oriented than horizontally oriented when the bottom of the dispenser is releasably secured to the horizontal surface.

2. The dispenser of claim 1, wherein the means for releasably and repeatedly securing is one of: one or more suction cups arranged on the bottom of the dispenser, a sticky pad arranged on the bottom of the dispenser and a tacky layer arranged on the bottom of the dispenser.

3. The dispenser of claim 1, wherein the dispensing opening includes a central axis passing through the dispensing opening that intersects with a central axis of the cylindrical volume.

4. The dispenser of claim 1, wherein the dispenser comprises a dome-shaped part positioned on top of the housing and including the dispensing opening, wherein the dispensing opening is located offset from an apex of the dome-shaped part.

5. The dispenser of claim 1, further comprising a handle to allow portability of the dispenser and for releasing the dispenser from the horizontal surface.

6. The dispenser of claim 4, wherein the dispenser further comprises a handle that is provided as an opening in the dome-shaped part.

7. The dispenser of claim 1, further comprising an openable part connected to the housing to allow the housing to be refilled with a new roll of centre-fed sheet material.

8. A system comprising the dispenser of claim 1, and a wall mounting part that is to be fixed to a vertical wall, whereby the dispenser is releasably connectable to the wall mounting part to allow the dispenser to be portable when released from the wall mounting part and to be docked at a fixed location when connected to the wall mounting part.

9. The system of claim 8, wherein the wall mounting part includes first and second arms, and the housing includes first and second slots, wherein the first and second arms spread apart to receive the housing and include first and second ribs to snap fit in first and second slots in the housing when the first and second arms are spread apart.

10. A dispenser, comprising:
a housing defining an interior cylindrical volume defining a central axis, the cylindrical volume for containing a centre-fed roll of sheet product material and a dispensing opening through which the sheet material is dispensed, and at least one restriction blade defining a restriction tunnel at least partly surrounding the dispensing opening, wherein the at least one restriction blade defines an entrance end of the restriction tunnel and a dispensing end of the restriction tunnel through which sheet material passes to pass out of the dispensing opening, and wherein the at least one restriction blade has an edge at the entrance end upon which an end face of the roll is to be seated, the edge extending along a plane perpendicular to the central axis of the cylindrical volume.

11. The dispenser of claim 10, wherein the dispensing opening is offset from the central axis of the cylindrical volume.

12. The dispenser of claim 10, wherein the at least one restriction blade provides a portion of the restriction tunnel located radially between the central axis of the cylindrical volume and the dispensing opening.

13. The dispenser of claim 12, wherein the portion of the restriction tunnel is curved so as to be radially closer to the central axis at a central part of the housing than at opposed outer parts along the at least one restriction blade.

14. The dispenser of claim 10, wherein the dispensing end of the restriction tunnel is an exit to the restriction tunnel provided by the dispensing opening itself.

15. The dispenser of claim 10, wherein the dispensing opening defines teeth along at least part of the dispensing opening against which the sheet material is separated from the roll.

16. The dispenser of claim 10, wherein the at least one restriction blade extends at least substantially radially on opposed sides of the dispensing opening from a circumferential plane extending along an outer circumferential edge of the cylindrical volume to a central portion of the cylindrical volume.

17. The dispenser of claim 10, further comprising at least one guide blade extending from a circumferential plane extending along an outer circumference of the cylindrical volume and intersecting with the at least one restriction blade, wherein the at least one guide blade defines an edge upon which an end face of the roll is to be seated, the edge extending along the plane perpendicular to the central axis of the cylindrical volume.

18. The dispenser of claim 17, wherein the at least one guide blade comprises a radially extending portion along the at least one guide blade, and a curved transition portion between the radially extending portion and an intersection with the at least one restriction blade.

19. The dispenser of claim 18, wherein the curved transition portion is convex relative to the central axis of the cylindrical volume.

20. The dispenser of claim 17, wherein the dispenser two guide blades defining a sector therebetween in the cylindrical volume.

21. The dispenser of claim 20, wherein the sector comprises at least a quadrant.
